(19) United States
(12) Patent Application Publication
(10) Pub. No.: US 2007/0198150 A1
(43) Pub. Date: Aug. 23, 2007

(54) System For Monitoring Condition Of Wheel

(76) Inventors: Manabu Kato, Aichi-ken (JP); Eiji Fujioka, Aichi-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 10/592,512

(22) PCT Filed: Mar. 8, 2005
(86) PCT No.: PCT/JP05/03960

§ 371 Date: Sep. 12, 2006

(30) Foreign Application Priority Data
Mar. 12, 2004 (JP) 2004-070926

(51) Int. Cl. G05D 1/00

(52) U.S. Cl. 701/37; 701/1

(57) ABSTRACT

To provide a system for monitoring the condition of a wheel that has a high mountability and can adequately transmit and receive measurement information about a wheel using radio wave transmission. A system for monitoring the condition of a wheel 7 includes: a measurement section 5 that obtains measurement information about the wheel 7; and a transmitter section 5b that transmits by radio the measurement information obtained by the measurement section 5, which are located on the side of the wheel 7; and a receiver section 2 that receives the measurement information transmitted by radio from the transmitter section 5b; and an information processing section 6 that determines the condition of the wheel 7 based on the measurement information S2a received by the receiver section 2, which are located on the side of a vehicle body, in which a transmitting antenna 4 that transmits by radio the measurement information S0 using a polarized wave that is in parallel with the rotational axis of the wheel 7 is provided on the side of the wheel 7, and a receiving antenna 1 sensitive to a polarized radio wave that is perpendicular to the direction of travel of the vehicle and in parallel with the ground is provided on the side of the vehicle body.

### TECHNICAL FIELD

The present invention relates to a system for monitoring the condition of a wheel, the system comprises a measurement section that obtains measurement information about a wheel and a transmitter section that transmits by radio the measurement information obtained by the measurement section, both of which are located on the side of the wheel, and a receiver section that receives the measurement information transmitted by radio from the transmitter section and an information processing section that determines the condition of the wheel based on the measurement information received by the receiver section, both of which are located on the side of a vehicle body.

### BACKGROUND ART

In a system in which the condition of an external device outside a vehicle body, such as the air pressure of a tire, is measured, and the measurement result is transmitted by radio to an information processing device that uses the measurement result inside the vehicle body, a weak radio wave is used for the radio transmission. Therefore, a high sensitivity antenna has to be installed to adequately receive the weak radio wave on the receiver side, or a receiving antenna has to be disposed in the vicinity of the transmitter section.

However, to increase the sensitivity of an antenna, the size of the antenna has to be undesirably increased. In the case of disposing an antenna in the vicinity of the transmitter section, another device may be already disposed at the intended place. For example, in order to monitor the air pressure of a tire, the antenna is preferably disposed in the vicinity of the wheel unit including the tire and the wheel. However, a wheel braking device, a wheel rotation detection device or the like is already disposed at the place. Therefore, it is difficult to dispose the antenna at a preferred place without interfering with the installation of other systems including a braking system and a wheel speed sensor and the operation of a moving part such as a suspension.

To solve the problem, in the patent document 1 (Japanese Patent Application “Kokai” No. 10-309914), there is described a method of using a signal line of a wheel speed sensor as an antenna. This method has advantages that an end of the antenna can be disposed in the vicinity of a tire, and that no additional antenna component is needed.

Patent document 1: Japanese Patent Application “Kokai” No. 10-309914 (paragraph nos. 0003-0006, 0010, 0011, 0029)

### DISCLOSURE OF THE INVENTION

1. Problem to be Solved by the Invention

The technique described in the patent document 1 uses the difference between the frequency of the signal from the wheel speed sensor and the frequency of the radio wave transmission. The frequency of the detection signal of the wheel speed sensor is on the order of 5 kHz to 10 kHz. The frequency of the radio wave transmission using a weak radio wave is on the order of 300 MHz to 320 MHz, for example. The frequencies greatly differ from each other, so that the signals can be separated.

However, to separate the signals, the signals have to be passed through a low-pass filter, a high-pass filter or the like. Thus, there is a problem that, in the course of filtering, the desired signal can be attenuated by each filter and become unable to be picked up.

The present invention has been devised in view of the problems described above, and an object thereof is to provide a system for monitoring the condition of a wheel that has a high mountability and can adequately transmit and receive measurement information about a wheel using radio wave transmission.

2. Means for Solving Problem

In order to attain the object described above, a system for monitoring the condition of a wheel according to the present invention is characterized in that a transmitting antenna for transmitting by radio measurement information using a polarized wave that is in parallel with the rotational axis of the wheel is located on the side of the wheel, and a receiving antenna sensitive to a polarized radio wave that is perpendicular to the direction of travel of the vehicle and in parallel with the ground is located on the side of the vehicle body.

With such a configuration, if the wheel rotates, the transmitting antenna transmits a polarized wave that is in parallel with the rotational axis of the wheel independently of the rotation of the wheel, and the receiving antenna, which is sensitive to the polarized radio wave in parallel with the rotational axis of the wheel, receives the transmitted polarized wave. This is because the direction perpendicular to the direction of travel of the vehicle and in parallel with the ground coincides with the direction of the rotational axis. Settings of the receiving antenna associated with each wheel are determined so that it can work the same way as a dipole antenna that is omnidirectional in a plane that includes the direction of travel of the vehicle and is perpendicular to the ground. As a result, the plane of polarization of the transmitted wave and the plane of polarization of the received wave coincide with each other, and the radio communication can be adequately achieved using a peak of reception sensitivity.

Furthermore, if the receiving antenna is disposed in the vicinity of the rotational axis of the wheel, even when a measurement section disposed on the side of a tire and the wheel rotates, the distance between a transmitter section and the receiving antenna is less variable, and variations in reception intensity can be suppressed.

It is preferred that the system has a signal line for transmitting a detection signal output from an external device that detects the rotation of the wheel, and the receiving antenna is disposed along this signal line.

With such a configuration, along the signal line that transmits the detection signal from the external device that detects the rotation of the wheel, an antenna line separate from the signal line is provided. Therefore, the measurement information transmitted by radio can be transferred in the same paths as the detection signal from the external device.

In addition, even when one of the signal lines of a multi-core cable is used as the receiving antenna, it is a signal line that is separate from that for the detection signal from the external device. Thus, there is no need to separate the detection signal from the external device and the measurement information transmitted by radio. Therefore, the problem can be solved that a desired signal cannot be obtained because of an attenuation of the signal through a separator circuit.

A wheel speed sensor is disposed in the vicinity of the rotational axis of the wheel, and thus, the receiving antenna also extends in the vicinity of the rotational axis. As a result, if the measurement section disposed on the side of the tire and the wheel rotates, the distance between the transmitter section and the receiving antennas is less variable, and variations in reception intensity can be suppressed.

In addition, it is preferred that the receiver section is disposed at a position closer to the wheel than the information processing section.

If the receiver section and the information processing section are separately provided in this way, and the receiver section is disposed at a position closer to the wheel, the receiving antenna installed can have a length suitable for radio transmission.

Typically, the information processing section, which is located in the vehicle body, is disposed at a position without regard to the radio communication with the wheel. If the information processing section and the receiver section are disposed at separate positions, the receiver section can be placed by giving top priority to the reception sensitivity, such as the length of the receiving antenna. The information processing section requires a large installation area. However, the receiver section alone, which has a dedicated function, can be placed at a position close to the wheel.

A signal is transmitted to the information processing section after being subjected to a reception processing. Reception processings, which are performed in the receiver section as required, include signal amplification and frequency conversion. As a result, the signal to be transmitted to the information processing section can have an improved noise resistance, and the received measurement information can be used more appropriately.

Furthermore, it is preferred that the receiver section receives the measurement information transmitted by radio and superimposes the received measurement information on the detection signal output from the external device.

If the measurement information received by the receiver section is added to the detection signal output from the external device in this way, the number of wires to the information processing section can be decreased. In addition, as required, the received measurement information may be added to the detection signal from the external device after the signal is amplified or after the frequency is converted to an appropriate frequency.

Thus, compared with a case where a part of a signal line of the external device is used as an antenna to receive the radio signal, a signal having an increased intensity can be added to the detection signal from the external device. Thus, even if the signal is separated in a subsequent processing section, such as in the information processing section, the attenuation of the signal can be suppressed.

In addition, it is preferred that the receiver section receives the measurement information transmitted by radio and combines the received measurement information with the detection signal output from the external device.

With such a configuration, the measurement information is combined with the detection signal output from the external device after being received by the receiver section. The received measurement information may be demodulated and combined with the detection signal from the external device before being transmitted to the information processing section.

Furthermore, for example, the information processing section can simply read a required code from the combined signal, and any signal separation is not needed. That is, any signal processing involving a low-pass filter, a high-pass filter or the like is not needed. As a result, the problem of signal attenuation or the like does not arise, and a good system for monitoring the condition of a wheel can be provided.

In addition, it is preferred that the antenna has an overall length that is a quarter of the wavelength of the radio wave. Alternatively, it is preferred that the receiving antenna has an overall length that is ⅜ or ⅝ of the wavelength of the radio wave.

A representative linear antenna is a half-wave dipole antenna. However, the dipole antenna has a feeding point at the middle thereof and thus has a relatively low usability. Thus, a monopole antenna having a length that is a half of a half-wave (a ½ wavelength) is used. The monopole antenna can be considered as an asymmetric dipole antenna, that is, a part of the dipole antenna on one side of the feeding point at the middle thereof, so that calculations concerning the same can be easily performed. In addition, the input impedance can be halved from that of the dipole antenna. In the case where a monopole antenna is used, the length thereof is not limited to a quarter of the wavelength and may be ⅜ or ⅝ of the wavelength. Since the input impedance of the antenna also affects the resonance frequency, the actual length of the antenna in resonance slightly differs from the theoretical value, ½ wavelength. As described earlier, in the case of the half-wave, the impedance is high. Thus, it is preferred that the length of the antenna is ⅜ or ⅝ of the wavelength, which facilitate impedance matching.

In addition, it is preferred that the receiver section receives the measurement information transmitted by radio, modulates the frequency of the signal carrying the received measurement information to a lower frequency, and superimposes the signal on the detection signal output from the external device.

For example, in the case where the external device is a rotation sensor, the detection signal from the external device has a frequency on the order of 5 to 10 kHz. The received signal carrying the measurement information about the wheel has been modulated for radio transmission based on the carrier frequency, and the carrier frequency is on the order of several hundreds of MHz, for example. This received signal can be superimposed on the detection signal from the external device without being processed. However, once received, the high frequency of the signal becomes a cause of noise to other on-board devices or the like. Thus, it is preferred that the superimposition and transmission of the signal are performed after the frequency of the signal is reduced to some extent.

As described above, the frequency of the detection signal from the external device and the carrier frequency of the received signal differ largely. Therefore, even if the frequency of the received signal is reduced by a factor of 1/32 to 1/128, there still remains an about 100-fold to 1000-fold difference in frequency between the received signal and the detection signal from the external device. Therefore, it is not difficult to electrically separate the signals even if the signals have been superimposed by being simply added together.

In addition, it is preferred that the receiver section receives the measurement information transmitted by radio, modulates the frequency of the signal carrying the received measurement information to a lower frequency, and combines the signal with the detection signal output from the external device.

The combined signal can have a frequency adjusted to the frequency of the detection signal from the external device, so that it can be transmitted as a signal having a low frequency. For example, if the detection signal from the external device is to communicate the detection result by a predetermined pulse, it is combined with the measurement information by modifying the pulse width. If the external device is a rotation sensor, the detection signal of the rotation sensor indicates the rotational speed by the pulse period. In this case, the pulse period is not changed, but the pulse width is modified in various ways, and the received measurement information is represented by a combination of various pulse widths. The combination is achieved by demodulating the measurement information modulated by the carrier frequency, and coding the demodulated measurement information, and associating the resulting code with a pulse width. Alternatively, another method may be used. For example, the combination may be achieved by superimposing an identification pulse with the pulse period, without changing the pulse width.

As described above, the detection signal of the external device has a frequency on the order of 5 to 10 kHz. Therefore, the measurement information can be transmitted using a signal having a frequency substantially lower than the carrier frequency of several hundreds of MHz. As a result, the possibility that the signal becomes a cause of noise to the other on-board devices can be significantly reduced, and at the same time, the noise resistance of the transmission signal itself can be improved. Thus, the number of components for noise reduction can be reduced. In addition, since a subsequent signal separation or demodulation is not needed, a small-size logic circuit, a general purpose microcomputer or the like can be used to obtain two kinds of information.

In addition, it is preferred that the receiving antenna is disposed along a drive shaft.

If the antenna is disposed along the drive shaft, which coincides with the rotational axis of the tire, even when the measurement section and the transmitting antenna provided on the wheel rotate, the distance between the transmitting antenna and the receiving antenna does not vary significantly, and variations in reception intensity can be suppressed.

### BEST MODE FOR CARRYING OUT THE INVENTION

In the following, an embodiment of the present invention will be described with reference to the drawings. This embodiment will be described taking as an example a system that measures the air pressure of a tire of a vehicle and transmits the measurement result by radio to an information processing device, such as a microcomputer and a logic circuit, in the vehicle.

FIG. 1 is a cross-sectional view of a wheel unit 7 including a tire. A tire 7a is attached to a wheel 7b and rotates about a drive shaft 7c. The wheel unit 7 has an air pressure monitor (measurement section) 5 that determines the air pressure of the tire 7a from the pressure exerted on a valve unit for injecting/discharging air to/from the tire 7a. The air pressure monitor 5 rotates about the drive shaft 7c along with the tire 7a.

As shown in FIG. 2, the air pressure monitor 5 serving as the measurement section comprises an air pressure sensor 5a, a transmitter section 5b that transmits by radio the measurement information obtained by the air pressure sensor 5a, and a transmitting antenna 4 for the radio transmission.

Besides the air pressure sensor 5a, the air pressure monitor 5 may have a temperature sensor (not shown) and transmit the temperature of the air in the tire 7a as measurement information. The temperature information allows determination of an abnormal temperature and determination taking thermal expansion into account. Furthermore, the air pressure monitor 5 may have an acceleration sensor (not shown) and determine the timing of data transmission from the air pressure monitor based on the output of the acceleration sensor. Furthermore, in the case where the air pressure monitor 5 is driven by a battery, the battery voltage may be monitored, and information based on the battery voltage may be transmitted.

According to this embodiment, a radio wave having a carrier frequency of about 300 MHz, which is suitable for a weak radio station and is not shared with any other on-board systems including a keyless entry system, is used as a carrier for the radio wave transmission. If a radio wave within a frequency band that is close to those of other on-board systems but is not shared with the other systems is used, circuit components including a mixer circuit (a converter circuit for the carrier frequency) in a receiver section 2 can be shared if only some circuit constants are modified. Thus, the system can be manufactured at low cost.

The radio wave transmitted from the transmitting antenna 4 in the tire 7a is received by a receiving antenna 1. A signal S0 received by the receiving antenna 1 is processed by the receiver section 2 and then transmitted to an information processing section 6 as tire-air-pressure information S2a through wired transmission means, such as wiring on a printed circuit board. The information processing section 6 issues an alarm about an abnormal air pressure of the tire 7a or controls the vehicle based on a combination of the tire-air-pressure information and information transmitted from other sensors, actuators, switches and the like.

The receiving antenna 1 is oriented so that the antenna is sensitive to a radio wave having a polarization that coincides with the rotational axis of the tire 7a. That is, the antenna is oriented so that the antenna is sensitive to a radio wave having a polarization substantially perpendicular to the direction of travel of the vehicle and substantially parallel with the ground. For example, if the antenna is oriented in parallel with the drive shaft 7c, which coincides with the rotational axis of the tire 7a, the distance between the transmitting antenna 4 and the receiving antenna 1 does not vary significantly even if the air pressure monitor 5 and the transmitting antenna 4, which are disposed on the tire 7a and the wheel 7b, rotate. Thus, variations in reception intensity can be suppressed. In addition, the length of the receiving antenna 1 should be a quarter or more of the wavelength of the transmission radio wave.

According to this embodiment, a radio wave having a frequency of about 300 MHz is used.

Substituting the values into the formula: wavelength λ (m)=speed of light (m/s)/frequency (Hz),
wavelength λ (m)=3*10⁸(m/s)/300*10⁶(Hz).

That is, wavelength λ (m)=1 (m). Thus, a monopole antenna having a length of about 25 cm (a quarter of 1 m) or more is fabricated. Of course, depending on the place of installation, a monopole antenna having a length of ⅜ or ⅝ of the wavelength may be fabricated.

The transmitting antenna 4 is oriented in the tire 7a so that the polarization of the radio wave transmitted by the transmitter section 5b is substantially in parallel with the rotational axis of the tire 7a. That is, the transmitting antenna 4 transmits a radio wave having a polarization that is substantially perpendicular to the direction of travel of the vehicle and substantially in parallel with the ground. Since the transmitting antenna 4 is disposed in the tire 7a, the transmitting antenna 4 is preferably a small antenna, such as a loop antenna and a helical antenna.

As described above, since the receiving antenna 1 and the transmitting antenna 4 are both oriented to receive a radio wave having a polarization that is substantially perpendicular to the direction of travel of the vehicle and substantially in parallel with the ground, transmission and reception can be achieved adequately. Therefore, the measurement information obtained by the air pressure monitor 5 can be adequately transmitted to the information processing section 6 via the receiver section 2.

Here, the polarization and the antenna orientation substantially perpendicular to the direction of travel of the vehicle mean that the polarization and the orientation form an angle of 45 degrees or less with the direction perpendicular to the direction of travel. In addition, the polarization and the antenna orientation substantially in parallel with the rotational axis of the tire 7a mean that the polarization and the antenna orientation form an angle of 45 degrees or less with the rotational axis of the tire 7a. The polarization and the antenna orientation substantially in parallel with the ground mean that the polarization and the antenna orientation form an angle of 45 degrees or less with the flat ground.

Configured as described above, there can be provided a system for monitoring the condition of a wheel that has a high mountability and can adequately transmit and receive measurement information about a wheel using radio wave transmission.

### Second Embodiment

Now, a second embodiment will be described. A wheel unit 7 often has an external device for measuring the condition of a wheel, in addition to an air pressure monitor 5. For example, as shown in FIG. 1, a rotation sensor 8 that detects rotational conditions of the wheel unit 7, such as rotational speed and rotational direction, is provided in the vicinity of a drive shaft 7c that coincides with the rotational axis of a tire 7a.

The measurement information (detection signal) obtained by the rotation sensor 8, which is an exemplary external device, is transmitted to an information processing section 6 via a signal wire 10s as shown in FIG. 3, for example. The rotation sensor 8 itself is fixed and does not rotate with the tire 7a and a wheel 7b. Therefore, even wiring can be provided along the drive shaft 7c that coincides with the rotational axis. In this embodiment, the wiring is composed of three wires including the signal wire 10s, a power supply wire 10v and a grounding wire 10g. The signal wiring may be a multi-core cable having three cores, for example.

In addition to the wires 10v, 10s and 10g that transmit the measurement information (detection signal) obtained by the rotation sensor 8, a separate wire la serving as an antenna 1 for receiving the measurement information obtained by the air pressure monitor 5 is disposed. The wire 10a serving as the antenna 1 extends together with the wires for the rotation sensor 8 to the vicinity of the rotation sensor 8, which is disposed near the drive shaft 7c in the wheel unit 7, along the drive shaft 7c coinciding with the rotational axis of the wheel unit 7. Thus, the antenna 1 extends to the vicinity of a transmitter section 5b in the air pressure monitor 5. In addition, since the antenna 1 extends along the drive shaft 7c, the antenna can receive the transmission signal with its orientation aligned with the polarization of the signal. Thus, the antenna can adequately receive the measurement information from the air pressure monitor 5.

The antenna 1 may be any wire 10a that is separate from the wires 10v, 10s and 10g for the rotation sensor 8. As shown in FIG. 3, the antenna 1 may be a part of the multi-core cable 10. For example, in the case where a three-core cable is needed for transmitting the measurement information obtained by the rotation sensor 8, a four-core cable 10 is used, and one of the cores, that is, the wire 10a, is not connected to the rotation sensor 8 and is used as the antenna 1.

Of course, a three-core cable may be used as the multi-core cable 10, and a separate wire may be used as the antenna 1. Alternatively, four separate wires may be used.

As described above, a wire separate from the signal wiring for the external device such as the rotation sensor 8 is used to receive the radio wave signal from the air pressure monitor 5 and transmit the signal to the information processing section 6. Thus, the information processing section 6 does not need to electrically separate the low-frequency signal from the rotation sensor 8 from the high-frequency radio wave signal. Accordingly, the signals do not need to be passed through a low-pass filter or a high-pass filter for separation. Thus, no signal attenuation caused by such a filter circuit occurs. As a result, the measurement information obtained by the rotation sensor 8 and the air pressure monitor 5 can be adequately transmitted to the information processing section 6.

### Third Embodiment

Now, a third embodiment will be described with reference to FIG. 4. According to the third embodiment, a receiver section 2 is disposed in the middle of a separate wire 10a serving as an antenna 1. That is, the wire 10a is divided into two parts, and the part closer to a wheel unit 7 is used as the antenna 1. The other part is used as a signal wire to transmit signals from the receiver section 2 to an information processing section 6.

With such a configuration, the radio signal received by the antenna 1 can be received, demodulated, amplified or otherwise processed by the receiver section 2 before the S/N ratio thereof is degraded. If it is desirable that the size of the receiver section 2 disposed in the middle of the wire 10a is reduced to a minimum, the receiver section 2 can be constituted only by a mixer circuit (a converter circuit for the carrier frequency) that serves as a received signal processing circuit.

After being processed as described above, the signal is routed to the information processing section 6. Therefore, the noise resistance of the received radio signal can be increased, and the measurement information obtained by an air pressure monitor 5 can be transmitted to the information processing section 6 with reliability. In addition, since the wire 10a serving as the antenna 1 can be adapted to have a length suitable for the wavelength of the transmission radio wave by changing the position of the receiver section 2, the reception sensitivity can be improved.

Alternatively, the system may be configured as described below. The receiver section 2 is configured as a dotted-line part 2A shown in FIG. 4. The dotted-line part 2A is composed of a printed circuit board or a terminal board, for example. Signals transmitted through wires from a rotation sensor 8 are routed to the information processing section 6 via the dotted-line part 2A serving as the receiver section 2 composed of a printed circuit board or the like (referred to as receiver section 2A, hereinafter).

For example, a four-core cable 10 comprising wires 10v, 10s, 10g and 10a shown in FIG. 3 or similar cable is used for wiring from the wheel unit 7 to the receiver section 2A in FIG. 4. The signals from the rotation sensor 8 pass through the printed circuit board or terminal board constituting the receiver section 2A without being processed. Of course, a noise filter or the like may be inserted, as required.

The measurement information obtained by the air pressure monitor 5 processed by a receiver circuit (the receiver 2 in FIG. 4) implemented on the printed circuit board or the like constituting the receiver section 2A and the signals (detection signals) transmitted via the wires from the rotation sensor 8 and passing through the receiver circuit are routed to the information processing section 6 using a similar four-core cable 20 comprising wires 20v, 20s, 20g and 20a. With such a configuration, the signals can be routed through the receiver section 2A using the cables 10 and 20 made of the same material. The ease of procurement and inventory control is improved, so that the condition monitoring system according to the present invention can be manufactured at lower cost.

### Modification 1 of Third Embodiment

Alternatively, the system may be configured as shown in FIGS. 5 and 6. Instead of simply receiving the measurement information obtained by an air pressure monitor 5, a receiver section 2 may combine the measurement information obtained by the air pressure monitor 5 with the measurement information (detection signal) obtained by a rotation sensor 8 to generate a new signal and transmit the new signal to an information processing section 6. Since the two pieces of measurement information are combined, the number of wires from the receiver section 2 to the information processing section 6 can be reduced.

FIGS. 5 and 6 shows an example in which the receiver section 2 superimposes a modulated received signal S1a, which is measurement information obtained by the air pressure monitor 5, on a measurement information signal S8 (detection signal) obtained by the rotation sensor 8 to form a superimposed waveform S2b and then transmits the superimposed signal to the information processing section 6. Since a receiver circuit 2a amplifies a signal S0, the strength of the received signal S1a to be superimposed can be increased compared with a case where the wire for the measurement information signal S8 from the rotation sensor 8 is used directly as an antenna.

Here, the converted received signal S1a to be superimposed on the measurement information signal S8 from the rotation sensor 8 preferably has a frequency higher than that of the measurement information signal S8 (detection signal) from the rotation sensor 8, which is an external device, and lower than that of the radio wave carrying the measurement information obtained by the air pressure monitor 5. In this case, noise to the other on-board devices can be reduced, and the signal processing in the information processing section 6 can be simplified. This will be described in detail below.

The measurement information signal S8 (detection signal) from the rotation sensor 8 has a frequency on the order of 5 to 10 kHz, for example. The received signal S0, which is measurement information obtained by the air pressure monitor 5, is modulated for radio transmission and has a frequency on the order of 300 MHz, for example. The received signal S0 can be superimposed on the measurement information signal S8 from the rotation sensor 8 without being processed. However, once received, the high frequency of the received signal S0, which has been a radio signal, becomes a cause of noise to other on-board devices. Thus, the received signal S0 is preferably transmitted to the information processing section 6 after the frequency thereof is reduced to some extent.

For example, if a mixer circuit or the like in the receiver section 2 performs frequency reduction by a factor of 1/32, the received signal S1a still has a frequency of about 10 MHz. In this case, there still remains an about 1000-fold difference in frequency between the received signal S1a and the measurement information signal S8 from the rotation sensor 8. Therefore, it is not difficult for the information processing section 6 to electrically separate the signals even if the signals have been simply added together.

In addition, since the signal S0 received by the receiver circuit 2a can be amplified, the received signal S1a having a sufficiently increased strength can be superimposed on the measurement information signal S8 (detection signal) from the rotation sensor 8. As a result, the influence of a signal attenuation on the signal separation by the information processing section 6 can be reduced.

### Modification 2 of Third Embodiment

Alternatively, as shown in FIGS. 7 and 8, a receiver section 2 may demodulate measurement information obtained by an air pressure monitor 5 and modulated by a transmitter section 5b, combine the demodulated measurement information with a measurement information signal S8 (detection signal) from a rotation sensor 8 to form a combined waveform S2b, and then transmit the combined signal to an information processing section 6. This will be described in detail below.

First, a receiver circuit 2a receives, amplifies and demodulates measurement information obtained by an air pressure monitor 5. Then, a signal processing circuit 2b combines the demodulated measurement information S1b obtained by the air pressure monitor 5 with a measurement information signal S8 (detection signal) from a rotation sensor 8. In the example shown in FIG. 8, pulses of the measurement information signal S8 (detection signal) from the rotation sensor 8, whose period represents the rotational speed of a wheel, are used as a carrier, and the demodulated measurement information S1b from the air pressure monitor 5 is combined with the carrier.

For example, as shown in FIG. 8, the combination is achieved by modifying the widths of the pulses of the measurement information signal S8 (detection signal) from the rotation sensor 8 in accordance with the codes (1 or 0) in the demodulated measurement information S1b from the air pressure monitor 5. That is, the pulse period represents the rotational speed of a wheel measured by the rotational sensor 8, and a combination of pulse widths provides the information about the air pressure measured by the air pressure monitor 5.

In this embodiment, only two kinds of codes 1 and 0 are shown for illustrative purposes. However, three or more kinds of pulse widths can be used including those representing a start bit, a stop bit and the like.

In addition, the signal combining method is not limited to the method of modifying the pulse width, and a method of modifying the pulse shape can be used. For example, the codes 1 and 0 may be represented by varying the pulse amplitude or by superimposing another identification pulse.

With such a configuration, all the signals transmitted to the information processing section 6 can have a reduced frequency. Since the measurement information signal S8 from the rotation sensor 8 has a frequency on the order of 5 to 10 kHz, the measurement information can be transmitted to the information processing section 6 using signals having a reduced frequency including the signal from the air pressure monitor 5.

As a result, the possibility that the signals become a cause of noise to the other on-board devices can be reduced significantly, and the noise resistance of the transmission signal itself can be improved. In addition, the number of components for noise reduction can be reduced. In addition, since the information processing section 6 does not need to perform signal separation, demodulation and the like, a small-size logic circuit or a microcomputer that is not high-performance can be used. In addition, since the number of processing steps performed by the information processing section 6 is reduced, the measurement information can be used immediately and smoothly.

As shown in FIGS. 5 and 7, as the signal wires, a four-core cable 10 and a three-core cable 20 may be used.

With the configuration described above, there can be provided a system for monitoring the condition of a wheel that has a high mountability and can adequately transmit and receive measurement information about a wheel using radio wave transmission.

### INDUSTRIAL APPLICABILITY

The present invention can be applied to a condition monitoring system that transmits, by radio, measurement information about a part of a vehicle the measurement information about which is difficult to transmit by wired means. More specifically, the present invention can be applied to a system for monitoring the condition of a wheel that monitors the condition of a wheel by measuring the air pressure, the air temperature or the like in a tire on the wheel and transmitting the measurement result to a vehicle-body-side device.

### BRIEF DESCRIPTION OF THE DRAWINGS

FIG. 1 is a cross-sectional view showing a configuration of a wheel unit;

FIG. 2 is a block diagram showing an exemplary system for monitoring the condition of a wheel according to the present invention;

FIG. 3 is a block diagram showing an exemplary system for monitoring the condition of a wheel according to the present invention;

FIG. 4 is a block diagram showing an exemplary system for monitoring the condition of a wheel according to the present invention;

FIG. 5 is a block diagram showing an exemplary system for monitoring the condition of a wheel according to the present invention;

FIG. 6 shows waveforms for illustrating an exemplary signal processing performed in the case of the configuration shown in the block diagram of FIG. 5;

FIG. 7 is a block diagram showing an exemplary system for monitoring the condition of a wheel according to the present invention; and

FIG. 8 shows waveforms for illustrating an exemplary signal processing performed in the case of the configuration shown in the block diagram of FIG. 7.

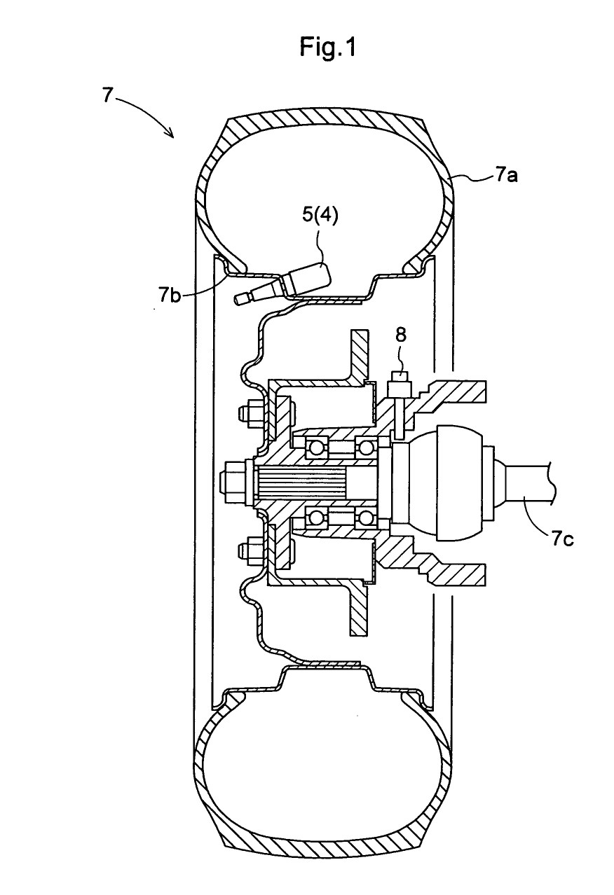

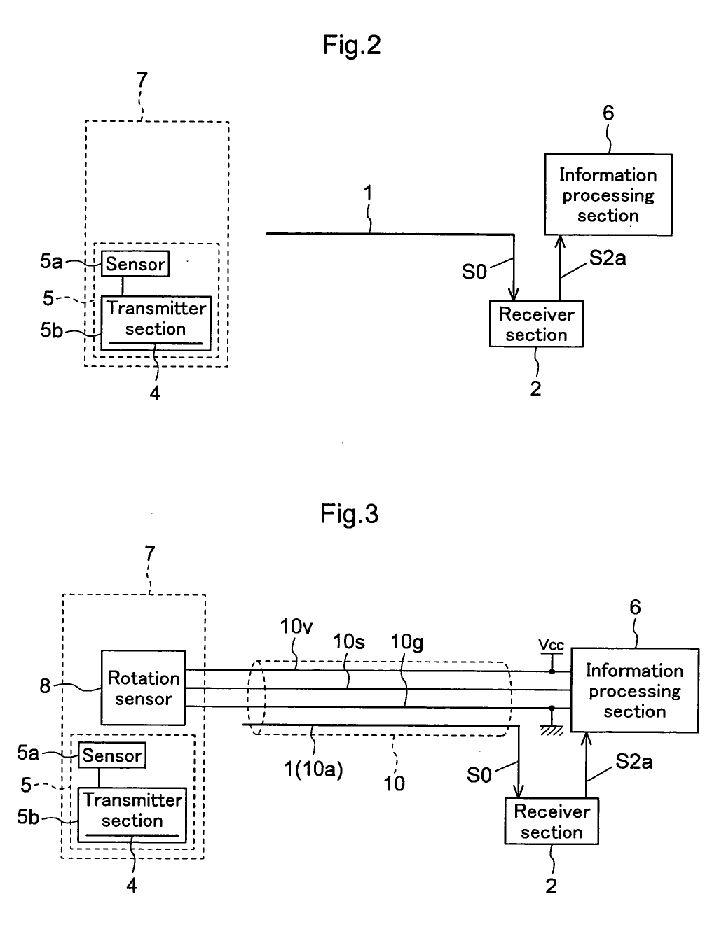

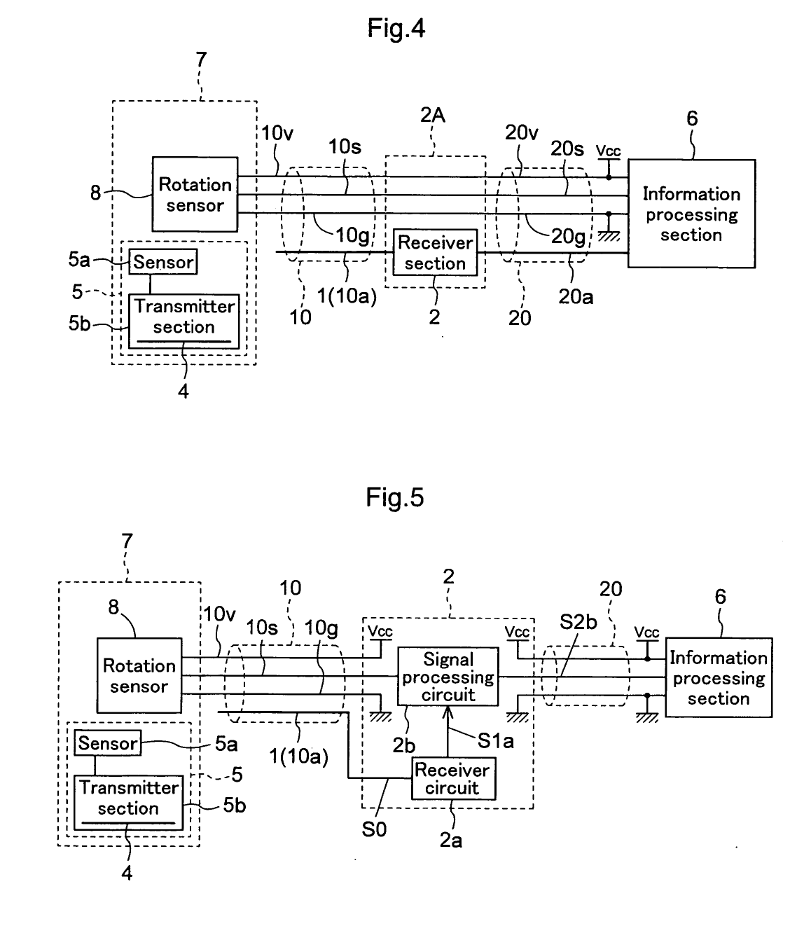

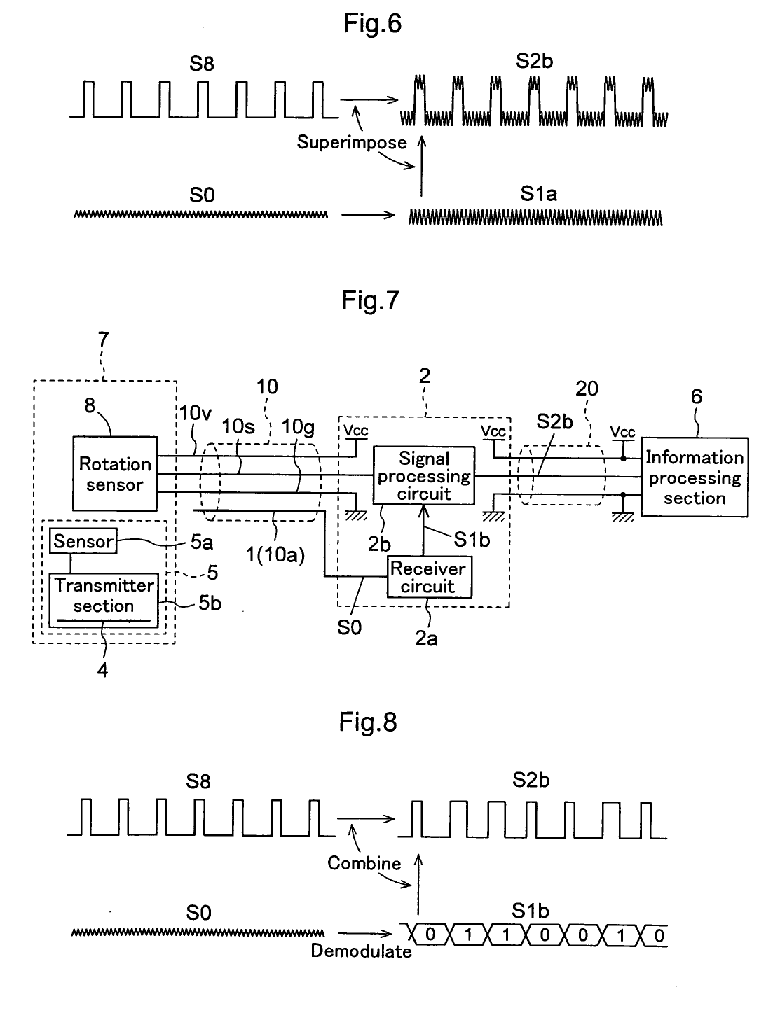

### DESCRIPTION OF REFERENCE NUMERALS

1 receiving antenna
2 receiver section
4 transmitting antenna
5 air pressure monitor
5a air pressure sensor
5b transmitter section
6 information processing section
7 wheel unit
S0 measurement information transmitted and received by radio
S2a measurement information received by receiver section

1. A system for monitoring the condition of a wheel, comprising:
a measurement section that obtains measurement information about the wheel, which is located on the side of the wheel;
a transmitter section that transmits by radio the measurement information obtained by said measurement section, which is located on the side of the wheel;
a receiver section that receives the measurement information transmitted by radio from said transmitter section, which is located on the side of a vehicle body; and
an information processing section that determines the condition of said wheel based on said measurement information received by said receiver section, which is located on the side of the vehicle body,
wherein a transmitting antenna that transmits by radio said measurement information using a polarized wave that is in parallel with the rotational axis of said wheel is provided on the side of the wheel, and
a receiving antenna sensitive to a polarized radio wave that is perpendicular to the direction of travel of the vehicle and in parallel with the ground is provided on the side of the vehicle body.

2. The system for monitoring the condition of a wheel according to claim 1,
further comprising a signal line for transmitting a detection signal output from an external device that detects the rotation of said wheel,
wherein said receiving antenna is disposed along said signal line.

3. The system for monitoring the condition of a wheel according to claim 1,
wherein said receiver section is disposed at a position closer to said wheel than said information processing section.

4. The system for monitoring the condition of a wheel according to claim 2,
wherein said receiver section receives said measurement information transmitted by radio and superimposes said received measurement information on said detection signal output from said external device.

5. The system for monitoring the condition of a wheel according to claim 2,
wherein said receiver section receives said measurement information transmitted by radio and combines said received measurement information with said detection signal output from said external device.

6. The system for monitoring the condition of a wheel according to claim 2,
wherein said receiving antenna has an overall length that is a quarter of the wavelength of said radio wave.

7. The system for monitoring the condition of a wheel according to claim 2,
wherein said receiving antenna has an overall length that is ⅜ or ⅝ of the wavelength of said radio wave.

8. The system for monitoring the condition of a wheel according to claim 4,
wherein said receiver section receives said measurement information transmitted by radio, modulates the frequency of the signal carrying said received measurement information to a lower frequency, and superimposes the signal on said detection signal output from said external device.

9. The system for monitoring the condition of a wheel according to claim 5,
wherein said receiver section receives said measurement information transmitted by radio, modulates the frequency of the signal carrying said received measurement information to a lower frequency, and combines the signal with said detection signal output from said external device.

10. The system for monitoring the condition of a wheel according to claim 1,
wherein said receiving antenna is disposed along a drive shaft.
